(19) United States
(12) Patent Application Publication
(10) Pub. No.: US 2004/0116026 A1
(43) Pub. Date: Jun. 17, 2004

(54) Charged synthetic nonwoven filtration media and method for producing same

(75) Inventors: Don A. Kubose, Fowler, CA (US); Jin Young Choi, Wilbraham, MA (US); James T. Greene, North Attleboro, MA (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(73) Assignee: Filter Materials, Inc., Waupaca, WI

(21) Appl. No.: 10/729,060

(22) Filed: Dec. 5, 2003

Related U.S. Application Data
(60) Provisional application No. 60/431,086, filed on Dec. 5, 2002.

(51) Int. Cl. D04H 3/10; B32B 23/02

(52) U.S. Cl. 442/340; 442/165; 442/170; 442/171; 442/327; 442/361; 442/387; 442/388; 442/402; 28/107; 28/112

(57) ABSTRACT

A resin charged media can be a single or layered construction needled together to provide a graded-density structure of fine fibers intermixed with finer fibers. This resulting media possesses a higher particulate loading retention capability, particularly early in the filtration cycle, relative to other cellulose, spun-bonds, or other similar materials commonly applied to filtration applications where filtration is predominantly a surface-loading phenomenon. The filtration media provides for depth filtration with the multi-layered needled layers, thereby enhancing the overall particulate-holding capacity of the charged media. This results in more resistance to fine particulates and improvements in efficiency due to increased sub-micron particle loading. With the filter media consisting of a graded structure, surface loading phenomenon can be reduced and filter life improved. Since the layers in the media are physically combined using needling technology, they will not separate. Being constructed of synthetic, melt-bondable fibers, the charged filter media can be formed into various shapes, sizes, and configurations through conventional and other thermal-forming techniques such as hot air, seal bar, ultrasonic, or vibration welding.

This application claims priority to and the benefit of U.S. Provisional Patent Application No. 60/431,086, filed Dec. 5, 2002.

### FIELD OF THE INVENTION

This invention relates generally to porous medias that are used for filtering contaminants from fluids and to methods for making such medias. More particularly, this invention relates to a resin charged multi-component, synthetic nonwoven filtration media that demonstrates improved particle retention and enhanced performance capabilities in both efficiency and life and that is well suited for filter sheet and bag uses. It also relates to a method for making such media.

### BACKGROUND OF THE INVENTION

Early filtration media development was largely designed around the use of naturally occurring fibers such as wool, cellulose, and asbestos. Today, wool and cellulose still play an important role in filtration. With the development of new plastics, however, synthetic fibers are being incorporated into filtration media because of their enhanced properties and methods of formation.

With the expansion of these material choices, techniques have also been developed to yield fibers with improved properties such as larger surface area and charge. These properties result in improved filtration performance. For example, many filtration applications target the removal of submicron fine particulates while demanding low-pressure drop performance. Others require the capacity to handle high flow rates. The balancing of key properties and/or property tradeoffs are sometimes made to meet specific filtration requirements.

In many cases, low-pressure drop is achieved through the use of coarse fibers, typically 15 microns or larger. The fibers can be electrostatically or chemically charged so as to enhance the particle collection efficiency of small particles. However, exposure to elevated humidity, temperature, or to certain chemicals, can cause these medias to lose their effectiveness as a function of time. On the other hand, thin medias that are comprised of light-weight, uncharged fine fibers can collect small particles but do so at the expense of high pressure drop, low loading capacity and shortened life when compared to that of a coarse fiber media.

Many attempts have been made to balance the capacity, pressure, and overall life of filter media through various fiber combinations, binder selections, and processing configurations. For example, U.S. Pat. No. 6,211,100 issued to Legere et al discloses a synthetic composite filter of a melt-blown/spun-bond fiber material and a mixed fiber triboelectric material that are needled together. This mixture of fibers becomes electrically charged during the manufacturing process to impart filter efficiency improvements. In U.S. Pat. No. 5,085,784 issued to Ostreicher, the inventor claims a process for removing particulate contaminants from a fluid by passing the fluid through a filter media comprised of cellulose fiber, silica based particulate and a charge modified agent consisting of a cationic charge modifier. U.S. Pat. No. 5,223,139 issued to Ruger describes a flexible fleece-like material consisting of synthetic or natural fibers, ultra-finely fibrillated fibers, and inert porous particles incorporated into a filter medium. U.S. Pat. No. 4,734,208 issued to Pall et al. discloses a filter media with micro fibers prepared of glass and a cationic thermosetting binder resin of polyamine-epichlorohydrin. And U.S. Pat. No. 6,420,024 issued to Perez et al. discloses charged, melt-processed microfibers having a charged surface for use in a microfibrillated filter.

In the experience of these inventors, the combinations of materials disclosed in the prior art tend to yield a filter media with adequate performance, but those combinations are not without some disadvantages. For example, melt blown processing is an effective way to create high loft materials that result in high efficiencies. However, the high manufacturing costs, poor overall life of melt blown webs, and the inability to apply charged binders without affecting the fiber properties limit the filtration applications for that material.

The addition of cationic and anionic resins to conventional wood-based fibers with filler is also well known in the art. This wet-laid process provides an economical method for producing charged filter media. However, creating high loft or deep filters with minimal pressure drop can be challenging. Also, due to the hydrophobic nature of most synthetic fibers (i.e., polyethylenes, polypropylenes), the wetting of and acceptance of resins to these synthetic fibers is very difficult. Additionally, creating gradient or multi-layered medias is extremely difficult without large capital investments and process expertise.

Finally, methods to incorporate microfibrillated materials or micro-fibers into a filter media provides increased surface area for improved particle capture. Because of the fineness of these fibers, however, pressure drops can be very high and filter life can be shortened. Attempts to use charged glass micro-fibers or micro-fibers produced through melt process and water jet fibrillation in filter media have been made to impart strength to the overall filter. These methods require additional processing steps that make it difficult to produce an economical filter media for broad use in beverage, food, industrial, and pharmaceutical filtration applications.

In contrast to the prior art, the media of the present invention is a micro-denier and fine-denier fiber-blended, charged synthetic media with high filtration efficiencies and life. The media of the present invention can be manufactured cost effectively in single or multi-layered configurations and has a broad range of potential usage in beverage, food, industrial, and pharmaceutical filtration applications.

### SUMMARY OF THE INVENTION

The filtration media of the present invention comprises a resin charged multiple component, synthetic nonwoven media that has many advantages over conventional filter materials. Firstly, the resin charged media of the present invention can be a single or layered construction needled together to provide a graded-density structure of fine fibers intermixed with finer fibers. This resulting media possesses a higher particulate loading retention capability, particularly early in the filtration cycle, relative to other cellulose, spun-bonds, or other similar materials commonly applied to filtration applications where filtration is predominantly a surface-loading phenomenon. Secondly, the filtration media of the present invention provides for depth filtration with the multi-layered needled layers, thereby enhancing the overall particulate-holding capacity of the charged media. This results in more resistance to fine particulates and improvements in efficiency due to increased sub-micron particle loading. With the filter media consisting of a graded structure, surface loading phenomenon can be reduced and filter life improved. Thirdly, since the layers in the media of the present invention are physically combined using needling technology, they will not separate. This would otherwise result in efficiency losses due to channeling or gapping. Fourthly, being constructed of synthetic, melt-bondable fibers, the charged filter media of the present invention can be formed into various shapes, sizes, and configurations through conventional and other thermal-forming techniques such as hot air, seal bar, ultrasonic, or vibration welding. The charged filter media of the present invention can be formed into flat or curved filter sheets, pleated filters, filter cartridges, filter bags, filter tubes, and the like.

The combination of materials in the media of the present invention leads to a multi-component, charged synthetic nonwoven filtration media having enhanced performance in efficiency and life. The foregoing and other features of the present invention will be apparent from the detailed description that follows.

### BRIEF DESCRIPTION OF THE DRAWING

FIG. 1 is a schematic diagram and flowchart illustrating the steps utilized in manufacturing one preferred embodiment of the filter media of the present invention.

### DETAILED DESCRIPTION

Reference is now made to the drawing wherein like numbers represent like elements throughout, to the base material utilized in one preferred embodiment, to various examples of the preferred medias constructed in accordance with the method of the present invention, and to tests that the medias were subjected to for the purpose of demonstrating superior performance over medias constructed in accordance with the prior art.

Base Material

The base material employed in the manufacture of the filtration media of the present invention includes media preferably comprised of a mixed fiber material formed from 10-90% of micro-denier, or fine-denier polyester and/or polypropylene, and 90-10% of fine or coarse-denier polyester and/or polypropylene fibers preferably having 5 to 30 micron average fiber diameter. Additional base materials can include, for example: (1) 100% micro-denier, or fine denier polyester and/or polypropylene fibers on 10-90% micro-denier or fine-denier polyester and/or polypropylene, with 90-10% fine or coarse-denier polyester and/or polypropylene fibers; (2) 10-90% of micro-denier, or fine-denier polyester and/or polypropylene with 90-10% fine, or coarse-denier polyester and/or polypropylene fibers on 100% fine, or coarse-denier polyester and/or polypropylene fibers; and (3) 100% micro-denier, or fine denier polyester and/or polypropylene fibers on 100% fine, or coarse-denier polyester and/or polypropylene fibers, also preferably having 5 to 30 micron average fiber diameter.

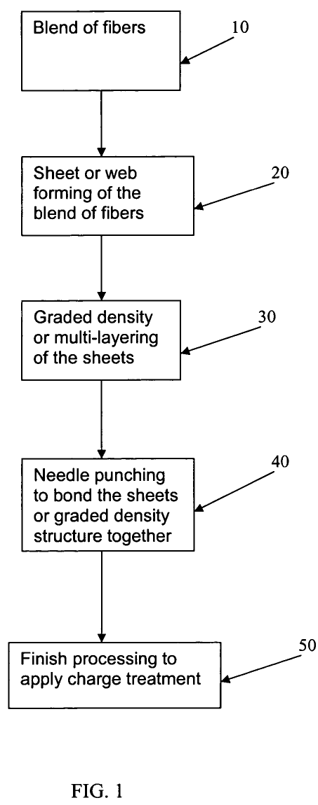

There are two preferred embodiments: a multi-layered, micro-denier blend structure, and a graded-density, micro-denier blend structure. In the first preferred embodiment, a mixture of 50% micro-denier and 50% fine-denier polyester fibers 10 are utilized, although other fibers and fiber deniers could be utilized as well. See FIG. 1. For example, a blend of polyester and polypropylene fibers can be utilized.

The first preferred embodiment preferably has a mixture weight of 300-600 grams/m². In the second preferred embodiment, a web layer of 15-micron polyester fiber, about one-third of total structure weight, is combined with multiple layers 30 of a mixture of 50% micro-denier and 50% fine-denier polyester fibers to form a multi-layered, bonded matrix having a gradient structure. This second media preferably has a total mixture weight of 400 to 800 grams/m². The gradient structure provides a mechanism for capturing particles based on size. These enhancements can extend the overall life of the filter.

In both embodiments, the fiber mixture is held together through the process of needlepunching 40. The fiber mixture becomes chemically charged during the nonwoven finishing manufacturing process. Preferably, a cationic resin 50 is applied to the needled media to impart an electrochemical charge. Filtration efficiency is particularly enhanced by the chemical charge on the fiber for capturing sub-micron-sized particles. An example of such a resin is polyamide-epichlorohydrin (PAE). Other resin types and charge-imparting processes can be utilized to employ charge to the media as well.

It is to be understood that the invention described above is not limited to any of the materials described above. Other single fibers or fiber blends may be formed from natural fibers (e.g. cotton, flax, silk, and wool) or other synthetic polymers such as acetates, acrylics, nylons, olefins, rayon, spandex, glass fibers, polylactic acid based fibers, and nanofibers, among others, without deviating from the scope of the present invention. The fibers may also contain various pigments, additives, strengthening aids, flow modifiers, and the like, and still come within the scope of the appended claims. In the experience of these inventors, other charge modifying resins may include, but are certainly not limited to, urea formaldehyde, melamine formaldehyde, and polyacrylamide. The process to form and apply the resin to the nonwoven is not limited, however, to nip coating. Other methods such as spray coating, electrospray, gravure, among others, could be used.

### EXAMPLE 1

This first example was a control that utilized a density-graded fiber structure known as PE-1-1MXL, a product of Lantor, Inc. Referring again to FIG. 1, a fine-denier and coarse-denier polyester staple fiber 10 were each processed separately. Each fiber type was pre-opened using standard practice and fed into a roller-top card, thereby producing a sheet or web 20. The web 20 is then machine layered 30 and lightly needle-punched 40 to produce a continuous cross-lapped baft having a weight of 150-200 grams/m². A fixed number of fine-denier batts were layered 30 on top of a coarse-denier layer, and then needle-punched 40. The resulting nonwoven is roughly an 80% fine-denier and 20%-coarse-denier graded-density structure. The needling scheme used with this EXAMPLE 1 is listed in the following Table 1.

TABLE 1

| | Needling Frequency | Penetration Depth |
|---|---|---|
| Web/Batt Carding Step | 85 pen/square-cm | 10 mm |
| Combining 4 Batt Layers | 95 pen/square-cm | 9 mm |
| Finish Needling Step | 95-130 pen/square-cm | 7 mm |

The needle-felt was then surface heat-treated and densified utilizing singeing and calendering operations. The fabric was flame treated to singe the surface protruding fibers on the “face” side of the nonwoven (i.e., the finer fiber side, or downstream side of the filter media). Then the fabric was continually preheated and pressed between a set of nip rollers at a temperature of between 120° C. and 190° C. This yielded fabric with higher density, decreased permeability, reduced pore size and heat treated surface finish. Varying the gap between nip rollers easily controls fabric gauge. The nip roll gap was adjusted to obtain a fabric target density of 0.173-0.234 grams/cm³.

### EXAMPLE 2

In this example, a sample of PE-1-1MXL grade filter media was treated 50 with a cationic resin using a procedure whereby a 7.62 cm die cut disk of PE-1-1MXL web was placed in a Petri dish containing 2 wt %—dry weight of a first aqueous mixture of cationic amine polymer epichlorohydrin adducts, a wet strength resin. The sample was allowed to soak 50 in the resin solution. The dish, containing the soaked sample, was placed in an oven at 120° C.

### EXAMPLE 3

The third example utilized a sample of PE-1-1MXL grade filter media consisting of up to 80% fine-denier and 20% minimum coarse-denier polyester fibers 10 that was treated 50 with a different cationic resin than that of EXAMPLE 2 by using the following procedure. A 7.62-cm die cut disk of PE-1-1MXL web was placed in a Petri dish containing 2 wt %—dry weight of a second aqueous solution of cationic amine polymer epichlorohydrin adduct, a wet strength resin. The sample was similarly allowed to soak 50 in the resin solution. The dish, containing the soaked sample, was placed in an oven at 120° C.

### EXAMPLE 4

In this example, PEMR-17100 fabric, a 50/50 blend of micro-denier and fine-denier polyester staple fiber 10, was pre-opened and mixed using standard practice and was fed into a roller-top card, thereby producing a web 20. The web 20 was then machine layered 30 and lightly needle-punched 40 to produce a continuous cross-lapped batt of 150-200 grams/m² in weight. Multiple baft layers were needle-punched 40 according to the combining and finish needling conditions listed in Table 1.

The needle-felt was then surface heat-treated and densified utilizing singeing and calendering operations. The fabric was flame treated to singe the surface protruding fibers on the “face” side of the nonwoven (i.e., the finer fiber side, or downstream side of the filter media). Then the fabric was continually preheated and pressed between a set of nip rollers at a temperature of 120° C. to 190° C., thereby yielding fabric with higher density, decreased permeability, reduced pore size and heat treated surface finish. Varying the gap between nip rolls easily controls fabric gauge. Nip roll gap was adjusted to obtain a fabric target density of 0.173-0.234 grams/cm³.

### EXAMPLE 5

In this example, materials produced in EXAMPLE 4 were resinated 50 with a charge modifying resin at 2 wt %—dry weight of an aqueous solution of cationic amine polymer epichlorohydrin adduct, a wet strength resin using the following parameters.

The base needle-felt, PEMR-17100 fabric was fed into a continuous padder-dryer process through a series of rollers, including a spreader roll to straighten out the folds and wrinkles, and passed in and out of a padder trough containing resin mix so as to completely saturate the fabric 50. The fabric was then passed through the padder roll nip to squeeze out excess resin and to control proper wet pick-up of the resin onto the fabric. The fabric was then pinned onto a tenter and passed through an oven, at temperatures up to 150° C. for drying.

### EXAMPLE 6

In this example, PEMR-22120 fabric, a graded-density micro-denier and fine-denier polyester staple fiber blend were processed separately. Each fiber type/blend was pre-opened using standard practice and fed into a roller-top card, producing a web. The web is then machine layered and lightly needlepunched to produce a continuous crosslapped batt of 150-200 grams/m² in weight. A fine-denier web layer of 15-micron polyester fiber is combined with multiple layers of a mixture of 50% micro-denier and 50% fine-denier polyester fibers and needlepunched to form a multi-layered, gradient structure. The resulting nonwoven is roughly 65% micro-denier blend and 35% fine-denier polyester graded-density structure. The needling scheme used is listed in Table 1.

The needle-felt was then surface heat-treated and densified utilizing singeing and calendering operations. The fabric was flame treated to singe the surface protruding fibers on the “face” side of the nonwoven (i.e., the finer side, or downstream side of a filter media). Then the fabric was continually preheated and pressed between a set of nip rolls at a temperature of 120-190° C., yielding fabric with higher density, decreased permeability, reduced pore size and heat treated surface finish. Varying the gap between nip rolls easily controls fabric gauge. Nip roll gap was adjusted to obtain a fabric target density of 0.219-0.276 grams/cm³.

### EXAMPLE 7

In this example, materials produced in Example 6 were resinated with charge modifying resin at 2 wt %—dry weight of an aqueous solution of cationic amine polymer epichlorohydrin adduct, a wet strength resin using the following parameters.

The graded-density base needle-felt, PEMR-22120 fabric, was fed into a continuous padder-dryer process through series of rollers, including a spreader roll to straighten out the folds and wrinkles, and passed in and out of the padder trough containing resin mix to completely saturate the fabric. The fabric passes through the padder nip roll and excess resin is squeeze out to control resin pick-up of the fabric. The fabric is then pinned onto a tenter and is passed through an oven, at temperatures up to 160 C. for drying.

### EXAMPLE 8

In this example, which is really a control sample, an Ultrafit® welded liquid filter bag from Filtration Systems, Division of Mechanical Mfg. Corporation, product number 500-P0001-P2 described as a 8 multi-layered, 5-micron uncharged bag, was used without modification or processing as a comparative example for test purposes.

### Test Methods.

Dye Testing

Metanil yellow, a water-soluble anionic dye, was used as a contaminant test for the resin-charged media 50. Metanil yellow is a dye particle that is extremely small, typically between 9 Å-18 Å. The dye particle is actually smaller than most of the pores in the filter pad itself. In this test method, the media sample is challenged, at a specific flow rate, with an aqueous dispersion of Metanil yellow adjusted to a pH of 3.47 to 3.50. Light transmittance is then measured with a spectrophotometer. The light transmittance of the effluent is measured as a function of throughput through the filter. A reduction in the absorbance value indicates that the charge applied to the pad is capturing the small dye particles from the fluid stream through electrochemical means. Typically, the dye tests are terminated once the absorbance value reaches 80% of the absorbance of the starting dye challenge.

The dried resin impregnated examples of EXAMPLES 2, 3, 4, 5, 6, and 7, the untreated EXAMPLE 8 and the untreated needle-felt control of EXAMPLE 1, were each cut into a 47 mm. disk. The disc was then placed into a 5.10 cm diameter glass housing sealed with a silicone gasket. The housing was equipped with a pressure transducer and the inlet from a peristaltic pump to a Metanil yellow challenge. The challenge stream was delivered to the pad at a flow rate of 20 ml/minute. The filtrate was collected in 25 ml aliquots and measured for absorbance using the spectrophotometer. The results of this test are shown in the following Tables 2A, 2B, and 2C.

TABLE 2A
Metanil Y llow Results

| Example 1 | | Example 2 | | Example 3 | |
|---|---|---|---|---|---|
| Time | | Time | | Time | |
| (min- | Absorbanc | (min- | Absorbance | (min- | Absorbance |
| utes) | (0.838 nm) | utes) | (0.838 nm) | utes) | (0.838 nm) |
| 0.50 | 0.809 | 0.50 | 0.128 | 0.00 | 0.049 |
| 3.00 | 0.806 | 3.00 | 0.307 | 3.00 | 0.080 |
| | | 6.00 | 0.399 | 6.00 | 0.192 |
| | | 9.00 | 0.449 | 9.00 | 0.257 |
| | | 13.00 | 0.507 | 13.00 | 0.346 |
| | | 17.00 | 0.546 | 17.00 | 0.419 |
| | | 23.00 | 0.593 | 23.00 | 0.495 |
| | | 25.00 | 0.603 | 25.00 | 0.512 |

TABLE 2B
Metanil Yellow Results

| Example 4 | | Example 5 | |
|---|---|---|---|
| Time | Absorbance | Time | Absorbance |
| (minutes) | (1.342 nm) | (minutes) | (1.342 nm) |
| 1.25 | 0.315 | 1.25 | 0.040 |
| 2.50 | 1.117 | 3.75 | 0.351 |
| | | 5.00 | 0.405 |
| | | 7.50 | 0.490 |
| | | 10.00 | 0.556 |
| | | 15.00 | 0.667 |
| | | 20.00 | 0.735 |
| | | 25.00 | 0.787 |
| | | 30.00 | 0.832 |
| | | 40.00 | 0.895 |
| | | 50.00 | 0.944 |
| | | 60.00 | 1.004 |

TABLE 2C
Metanil Yellow Results Cont'd

| EXAMPLE 6 | | EXAMPLE 7 | | EXAMPLE 8 | |
|---|---|---|---|---|---|
| Time | | Time | | Time | |
| (min- | Absorbance | (min- | Absorbance | (min- | Absorbance |
| utes) | (0.762 nm) | utes) | (0.762) | utes) | (0.762 nm) |
| 1.3 | 0.715 | 1.3 | 0.217 | 1.3 | 0.695 |
| | | 2.5 | 0.273 | | |
| | | 5.0 | 0.320 | | |
| | | 10.0 | 0.380 | | |
| | | 20.0 | 0.444 | | |
| | | 30.0 | 0.497 | | |
| | | 40.0 | 0.535 | | |
| | | 50.0 | 0.563 | | |
| | | 60.0 | 0.585 | | |
| | | 70.0 | 0.595 | | |

The test results illustrated in Tables 2A through 2C show efficiency capture, or the removal of particles due to the cationic charge 50 of the resin. As previously alluded to, metanil yellow is a dye particle that is extremely small. The dye particle is smaller than most of the pores in the filter pad itself. The only way to affect removal of the dye particle is to create an electrochemical attraction from the charge of the resin. In Table 2A, EXAMPLE 1 results show that, within the first 3 minutes, the maximum absorbance is met (0.800 nm) thus showing no removal of the dye. However, EXAMPLE 2 and EXAMPLE 3 show that, over a 25 minute period of time, the resinated sheet continues to remove the dye particles. Neither example reaches the maximum absorbance limit. This clearly shows that the resin applied sheets produced by the method of the present invention possess adequate charge to improve the removal and retention of effluent particles.

The foregoing explanation holds true for the results set forth in Tables 2B and 2C. As shown, the controls of EXAMPLE 4 and EXAMPLE 6 do not remove any of the dye particles since there is no charge or electrochemical attraction. In addition, the comparative filter in EXAMPLE 8 does not remove any dye particles. To the contrary, EXAMPLE 5 and EXAMPLE 7 show excellent removal over a long period of time, i.e. 60 minutes. In resin charged media, the charge is usually dissipated quickly since the particles attracted to the resin charge fibers tend to shield other particles from the electrochemical charge. In this case, the charge is not dissipated quickly. It is submitted that this result clearly illustrates that filter media produced in accordance with the process of the present invention show uniform coverage of the resin throughout the pad layers which, in turn, demonstrates the concomitant excellent removal capacity of that filter media.

Pressure vs. Time

In this test, Arizona test dust supplied by Reade Manufacturing Ltd., with particle sizes ranging from. 0-20 microns, or 0-40 microns, were used in a contaminant challenge stream for measure of pressure build and overall throughput. In this test method, test specimens were each cut into a 47 mm disk and weighed. The disc was then placed into a 5.10 cm diameter glass housing sealed with a silicone gasket. The housing was equipped with a pressure transducer and the inlet from a peristaltic pump. Samples were challenged at a flow rate of 40.32 l/m² using the peristaltic pump, with an aqueous dispersion of an initial turbidity of approximately 300 or 500 NTU (nephelometric turbidity units). Pressure measurements versus time, or throughput, to determine overall life of the media were recorded. The test is complete when an increase of 10 psi (pounds per square inch) is met from the initial to final filtration pressure.

Turbidity vs. Time

Here again, Arizona test dust, with particle sizes ranging from 0-20 microns, or 0-40 microns, was used in a contaminant challenge stream for measuring final filtrate turbidity and overall throughput. In this test, a sample was each cut into a 47 mm disk and weighed. The disk was then placed into a 5.10 cm diameter glass housing sealed with a silicone gasket. The housing was equipped with a pressure transducer and the inlet from a peristaltic pump. The sample is challenged at a flow rate of 40.32 l/m² using the peristaltic pump with an aqueous dispersion of the test dust at an approximately 300 or 500 NTU level. Using a turbidimeter, turbidity measurements were taken of the unfiltered and filtered solution verses time, or throughput, and were recorded to determine efficiency of the media.

The dried resin impregnated filter of EXAMPLE 2, the untreated PE-1-1MXL needle-felt control of EXAMPLE 1, EXAMPLE 4, and EXAMPLE 5 were each cut into 47 mm discs and weighed. The discs were placed in 5.10 cm diameter glass housing sealed with a silicone gasket. The housing was equipped with a pressure transducer and the inlet from the peristaltic pump to an Arizona Dust (0-20 microns) challenge for EXAMPLES 1, 2, 4, and 5. The challenge stream was prepared at an initial turbidity level of 500 NTU to 530 NTU for EXAMPLES 1, 2, 4, and 5. The flow rate was set for 40.32 l/m² for all samples. Pressure, turbidities, and time were recorded. The test was allowed to continue until an increase of 10 psi was met from the initial to final filtration pressures in one of the samples. The results of this test are shown in the following Tables 3A and 3B.

The dried resin impregnated filters of EXAMPLES 6, 7 and the comparative EXAMPLE 8, were also tested for removal efficiency using a similar procedure as above. The 47 mm weighed discs were placed in a 5.10 cm diameter housing sealed with a silicone gasket. The housing was equipped with a pressure transducer and the inlet of the pump to an Arizona Test Dust (0-40 microns) challenge with an initial turbidity of approximately 300 NTU. The flow rate was set for 40.32 l/m² for these Examples. Pressure and time were recorded. The test was allowed to continue until an increase of 25 psi was met from the initial to final filtration pressures in one of the samples. Turbidities were measured off line of the initial, unfiltered challenge and the resulting filtrate. The results of this test are shown in the following Table 3C.

Percent Retention

Percent retention, a measure of removal efficiency, was calculated for each of the Examples tested. The percent retention was calculated by taking the initial turbidity of the starting challenge, subtracting the turbidity of the filtered challenge, dividing this by the initial turbidity of the starting challenge and multiplying by 100. This number represents the percentage of particles retained by that filter at the specified filtration process conditions. Values for each of the Examples can be found in Tables 3A, 3B and 3C.

Dirt Holding Capacity

Dirt holding capacity measurements for EXAMPLES 6 through 8 were conducted following the PRESSURE VS. TIME procedure. The pre-weighed 47 mm disks used in the PRESSURE VS. TIME and the TURBIDITY VS. TIME testing described above were removed from the 5.10 cm diameter glass housing after these tests and dried at 105° C. for 2 hours. The dried disks containing the entrapped dust particles were re-weighed. Dirt holding capacity values were reported as the final dried weight of the disk subtracted by the starting weight of the filter disk. This value represents the mass of dust retained by the filter pad at the specified filtration process conditions. Dirt holding capacities are included in Table 3C.

TABLE 3A
Pressure, Turbidity, and Time Results

| EXAMPLE 1 | | | EXAMPLE 2 | | |
|---|---|---|---|---|---|
| Time (min.) | PSI | NTU | Time (min.) | PSI | NTU |
| 0.0 | 0.20 | 0.11 | 0.0 | 0.40 | 0.09 |
| 2.0 | 0.40 | 143.36 | 2.0 | 0.50 | 46.04 |
| 4.0 | 0.40 | 229.36 | 4.0 | 0.50 | 97.04 |
| 6.0 | 0.30 | 248.36 | 6.0 | 0.40 | 188.36 |
| 8.0 | 0.30 | 262.36 | 8.0 | 0.50 | 135.36 |
| 10.0 | 0.30 | 285.36 | 10.0 | 0.60 | 156.36 |
| 14.0 | 0.30 | 297.36 | 14.0 | 0.60 | 188.36 |
| 20.0 | 0.40 | 339.36 | 20.0 | 0.90 | 198.36 |
| 24.0 | 0.30 | 355.36 | 24.0 | 1.50 | 181.36 |
| 28.0 | 0.40 | 343.36 | 28.0 | 2.70 | 125.36 |
| 32.0 | 0.50 | 364.36 | 32.0 | 4.90 | 93.54 |
| 34.0 | 0.50 | 379.36 | 34.0 | 5.90 | 81.74 |
| 39.0 | 0.50 | 364.36 | 39.0 | 10.50 | 20.03 |

| | |
|---|---|
| % Retention | % Retention |
| 37% | 79% |

TABLE 3B
Pressure, Turbidity, and Time Results Cont'd

| EXAMPLE 4 - no resin | | | EXAMPLE 5 - resinated | | |
|---|---|---|---|---|---|
| Time (min.) | PSI | NTU | Time (min.) | PSI | NTU |
| 0.0 | 0.06 | 0.05 | 0.0 | 0.01 | 0.06 |
| 2.0 | 0.04 | 190.00 | 2.0 | 0.09 | 42.80 |
| 4.0 | 0.06 | 246.00 | 4.0 | 0.06 | 178.00 |
| 6.0 | 0.04 | 229.00 | 6.0 | 0.09 | 198.00 |
| 8.0 | 0.06 | 244.00 | 8.0 | 0.09 | 203.00 |
| 10.0 | 0.11 | 247.00 | 10.0 | 0.09 | 227.00 |
| 14.0 | 0.14 | 267.00 | 14.0 | 0.16 | 265.00 |
| 20.0 | 0.11 | 273.00 | 20.0 | 0.21 | 239.00 |
| 24.0 | 0.23 | 285.00 | 24.0 | 0.31 | 253.00 |
| 28.0 | 0.21 | 293.00 | 28.0 | 0.60 | 246.00 |
| 32.0 | 0.33 | 287.00 | 32.0 | 1.24 | 225.00 |
| 34.0 | 0.26 | 277.00 | 34.0 | 1.87 | 246.00 |
| 39.0 | 0.70 | 235.00 | 39.0 | 4.07 | 207.00 |
| 42.0 | 1.24 | 228.00 | 42.0 | 6.14 | 169.00 |
| 46.0 | 2.48 | 192.00 | 46.0 | 11.00 | 54.30 |

| | |
|---|---|
| % Retention | % Retention |
| 52% | 60% |

TABLE 3C
Pressure and Time Results Cont'd

| EXAMPLE 6 | | EXAMPLE 7 | | EXAMPLE 8 | |
|---|---|---|---|---|---|
| Time (min.) | PSI | Time (min.) | PSI | Time (min.) | PSI |
| 0.0 | 0.40 | 0.0 | 0.58 | 0.0 | 1.36 |
| 5.0 | 0.43 | 5.0 | 0.58 | 5.0 | 1.46 |
| 10.0 | 0.43 | 10.0 | 0.58 | 10.0 | 2.38 |
| 20.0 | 0.48 | 20.0 | 0.58 | 20.0 | 6.92 |
| 30.0 | 5.48 | 30.0 | 1.02 | 30.0 | 13.91 |
| 40.0 | 10.14 | 40.0 | 2.53 | 40.0 | 20.60 |
| 47.0 | 13.27 | 47.0 | 4.19 | 47.0 | 26.50 |
| 50.0 | 14.54 | 50.0 | 4.97 | | |
| 60.0 | 18.47 | 60.0 | 8.22 | | |
| 70.0 | 22.67 | 70.0 | 12.5 | | |
| 80.0 | 25.40 | 80.0 | 17.84 | | |
| | | 90.0 | 23.06 | | |
| | | 95.0 | 25.72 | | |

| | | |
|---|---|---|
| % Retention | % Retention | % Retention |
| 80% | 97% | 98% |
| Dirt Holding | Dirt Holding | Dirt Holding |
| Capacity | Capacity | Capacity |
| 4.2 grams | 5.5 grams | 2.3 grams |

In Table 3A, the inventors are recording measurements of pressure build and particle removal efficiency. In most cases, these two properties tend to be related. For example, as the filter sheet begins to remove particles, the pores in the filter begin to clog and the pressure begins to build. In the experience of these inventors, it is important to balance these properties so as to insure good removal and good life, i.e. low pressure build over time, of the filter media. The measurements shown in Table 3A show the control sheet of EXAMPLE 1 to have low pressure build over time. However, the control pad also has poor retention properties. The control sheet of EXAMPLE 1 demonstrates 37% retention while the retention for EXAMPLE 2 is 79%. These test results show that resin impregnated filter media possesses superior particle removal and retention when produced by the process of the present invention and when compared to filter media that is not impregnated with,resin.

In Table 3B, the samples illustrated there, i.e. EXAMPLE 4 and EXAMPLE 5, show a similar trend. These inventors also found that the control sheet EXAMPLE 4 demonstrated a retention of 52% whereas the resin containing sheet of EXAMPLE 5 demonstrated that it out-performed the control with a 60% retention.

In Table 3C, the multi-layered needlefelt of EXAMPLE 6 showed poorer retention to EXAMPLE 7, the same needlefelt construction with the charged resin. Furthermore, the filter of EXAMPLE 7, consisting of two layers, shows equal retention characteristics to the comparative filter of EXAMPLE 8 which is comprised of 8 layers. However, EXAMPLE 7 shows twice the filter life of EXAMPLE 8 before reaching the 25 psi differential test limit.

Based on the foregoing, it has been demonstrated that filtration media produced in accordance with the method of the present invention comprises a charged multiple component, synthetic nonwoven media that has superior performance capabilities over conventional filter materials. The resin charged media of the present invention can be layered and needled together to provide a graded-density structure of fine fibers intermixed with finer fibers. This resulting media possesses a higher particulate loading retention capability, particularly early in the filtration cycle, relative to other cellulose, spun-bonds, or other similar materials commonly applied to filtration applications where filtration is predominantly a surface-loading phenomenon. The filtration media of the present invention also provides for depth filtration with the multi-layered needled layers, thereby enhancing the overall particulate-holding capacity of the media. This results in more resistance to fine particulates and improvements in efficiency due to increased sub-micron particle loading. With the filter media consisting of a graded structure, surface loading phenomenon can be reduced and filter life improved.

Additionally, since the layers in the media of the present invention are physically combined using needling technology, the layers will not separate. This would otherwise result in efficiency losses due to channeling or gapping. The filter media of the present invention can be formed into various shapes, sizes, and configurations through conventional and other thermal-forming techniques such as hot air seal bar, ultrasonic, or vibration welding. Finally, the resin applied sheets produced by the method of the present invention possess adequate charge to improve the overall removal and retention of effluent particles. In fact, test results provided as part of this detailed disclosure clearly show that resin impregnated synthetic filter media possesses superior particle removal and retention when produced by the process of the present invention and when compared to filter media that is not impregnated with resin.

The principles of this invention having been explained in accordance with the foregoing, we claim:

1. A method for producing a charged nonwoven filtration media which comprises the steps of
blending nonwoven fibers,
sheet forming the blend of fibers, and
applying a charge treatment to said sheets.

2. The method of claim 1 including, prior to said charge applying step, the steps of
multilayering a plurality of said sheets,
needle punching said plurality of sheets to bond them together.

3. The method of claim 1 wherein said blending step includes using polypropylene, polyester or other low melting temperature fibers in a blend to achieve enhanced thermal processing capabilities.

4. The method of claim 3 wherein said blending step comprises using 10-90% of polypropylene, including bi-component fibers, are used in a blend.

5. The method of claim 2 wherein the charge treatment applying step comprises applying a charged cationic or anionic resin to the bonded sheets.

6. The method of claim 5 wherein the applied cationic resin is polyamide-epichlorohydrin.

7. The method of claim 1 wherein the fabric density, air permeability, and mean pore size can be controlled through heated calendaring and densification of the bonded sheets, including smooth, textured, or patterned calendar rolls.

8. The method of claim 2 wherein the bonded sheets can be formed into flat or curved filter sheets, pleated filters, filter cartridges, filter bags, filter tubes, and the like.

9. A method for producing a charged multiple component, nonwoven filtration media which comprises the steps of
blending micro-denier/fine-denier blend fibers and fine-denier fibers,
sheet forming the blend of fibers,
multilayering a plurality of said sheets in a graded density structure,
needle punching said graded density structure to bond said sheets together, and
applying a charge treatment to said bonded sheets.

10. The method of claim 9 wherein said blending step includes using 10-90% of polypropylene or other low melting temperature fibers, including bi-component fibers, in a blend to achieve enhanced thermal processing capabilities.

11. The method of claim 9 wherein the charge applying step comprises applying a cationic or anionic resin to the bonded sheets.

12. The method of claim 11 wherein the applied cationic resin is polyamide-epichlorohydrin.

13. The method of claim 9 wherein the fabric density, air permeability, and mean pore size can be controlled through heated calendaring and densification of the bonded sheets, including smooth, textured, or patterned calendar rolls.

14. The method of claim 9 wherein the bonded sheets can be formed into flat or curved filter sheets, pleated filters, filter cartridges, filter bags, filter tubes, and the like.

15. A method for producing a charged multiple component, nonwoven filtration media which comprises the steps of
blending micro-denier/fine-denier blend fibers and coarse-denier fibers,
sheet forming the blend of fibers,
multilayering a plurality of said sheets in a graded density structure,
needle punching said graded density structure to bond said sheets together, and
applying a charge treatment to said bonded sheets.

16. The method of claim 15 wherein said blending step includes using 10-90% of polypropylene or other low melting temperature fibers, including bi-component fibers, in a blend to achieve enhanced thermal processing capabilities.

17. The method of claim 15 wherein the charge applying step comprises applying a cationic or anionic resin to the bonded sheets.

18. The method of claim 17 wherein the applied cationic resin is polyamide-epichlorohydrin.

19. The method of claim 15 wherein the fabric density, air permeability, and mean pore size can be controlled through heated calendaring and densification of the bonded sheets, including smooth, textured, or patterned calendar rolls.

20. The method of claim 15 wherein the bonded sheets can be formed into flat or curved filter sheets, pleated filters, filter cartridges, filter bags, filter tubes, and the like.

21. A method for producing a charged multiple component, nonwoven filtration media which comprises the steps of
blending micro-denier fibers and fine-denier fibers,
sheet forming the blend of fibers,
multilayering a plurality of said sheets in a graded density structure,
needle punching said graded density structure to bond said sheets together, and
applying a charge treatment to said bonded sheets.

22. The method of claim 21 wherein said blending step includes using 10-90% of polypropylene or other low melting temperature fibers, including bi-component fibers, in a blend to achieve enhanced thermal processing capabilities.

23. The method of claim 21 wherein the charge applying step comprises applying a cationic or anionic resin to the bonded sheets.

24. The method of claim 23 wherein the applied cationic resin is polyamide-epichlorohydrin.

25. The method of claim 21 wherein the fabric density, air permeability, and mean pore size can be controlled through heated calendaring and densification of the bonded sheets, including smooth, textured, or patterned calendar rolls.

26. The method of claim 21 wherein the bonded sheets can be formed into flat or curved filter sheets, pleated filters, filter cartridges, filter bags, filter tubes, and the like.

27. A method for producing a charged multiple component, nonwoven filtration media which comprises the steps of
blending micro-denier fibers and coarse-denier fibers,
sheet forming the blend of fibers,
multilayering a plurality of said sheets in a graded density structure,
needle punching said graded density structure to bond said sheets together, and
applying a charge treatment to said bonded sheets.

28. The method of claim 27 wherein said blending step includes using 10-90% of polypropylene or other low melting temperature fibers, including bi-component fibers, in a blend to achieve enhanced thermal processing capabilities.

29. The method of claim 27 wherein the charge applying step comprises applying a cationic or anionic resin to the bonded sheets.

30. The method of claim 29 wherein the applied cationic resin is polyamide-epichlorohydrin.

31. The method of claim 27 wherein the fabric density, air permeability, and mean pore size can be controlled through heated calendaring and densification of the bonded sheets, including smooth, textured, or patterned calendar rolls.

32. The method of claim 27 wherein the bonded sheets can be formed into flat or curved filter sheets, pleated filters, filter cartridges, filter bags, filter tubes, and the like.

33. A charged nonwoven filtration media which comprises
one or more sheets formed from blended nonwoven fibers, and
a charge treatment applied to said sheets.

34. The media of claim 33 wherein a plurality of said sheets are multilayered and needle punched to bond them together.

35. The media of claim 33 wherein said fibers are comprised of polypropylene, polyester or other low melting temperature fibers in a blend to achieve enhanced thermal processing capabilities.

36. The media of claim 33 wherein fibers of 10-90% of polypropylene, including bi-component fibers, are used in the blend.

37. The media of claim 33 wherein the charge treatment comprises a charged cationic or anionic resin.

38. The media of claim 37 wherein the cationic resin is polyamide-epichlorohydrin.

39. The media of claim 33 wherein the fabric density, air permeability, and mean pore size can be controlled through heated calendaring and densification of the bonded sheets, including smooth, textured, or patterned calendar rolls.

40. The media of claim 33 wherein the bonded sheets can be formed into flat or curved filter sheets, pleated filters, filter cartridges, filter bags, filter tubes, and the like.

41. A charged multiple component, nonwoven filtration media which comprises
a blend of micro-denier/fine-denier blend fibers and fine-denier fibers,
one or more sheets formed from the blend of fibers, said sheets being multilayered in a graded density structure and needle punched to bond said sheets together, and
a charge treatment applied to said bonded sheets.

42. The media of claim 41 wherein 10-90% of polypropylene or other low melting temperature fibers, including bi-component fibers, are used in the blend to achieve enhanced thermal processing capabilities.

43. The media of claim 41 wherein the charge applied is a cationic or anionic resin.

44. The media of claim 43 wherein the applied cationic resin is polyamide-epichlorohydrin.

45. The media of claim 41 wherein the fabric density, air permeability, and mean pore size can be controlled through heated calendaring and densification of the bonded sheets, including smooth, textured, or patterned calendar rolls.

46. The media of claim 41 wherein the bonded sheets can be formed into flat or curved filter sheets, pleated filters, filter cartridges, filter bags, filter tubes, and the like.

47. A charged multiple component, nonwoven filtration media which comprises
a blend of micro-denier/fine-denier blend fibers and coarse-denier fibers, said blend being formed into one or more sheets, said sheets being multilayered in a graded density structure and needle punched to bond said sheets together, and
a charge treatment applied to said bonded sheets.

48. The media of claim 47 wherein 10-90% of polypropylene or other low melting temperature fibers, including bi-component fibers, are used in a blend to achieve enhanced thermal processing capabilities.

49. The media of claim 47 wherein the charge applied is a cationic or anionic resin.

50. The media of claim 49 wherein the applied cationic resin is polyamide-epichlorohydrin.

51. The media of claim 47 wherein the fabric density, air permeability, and mean pore size can be controlled through heated calendaring and densification of the bonded sheets, including smooth, textured, or patterned calendar rolls.

52. The media of claim 47 wherein the bonded sheets can be formed into flat or curved filter sheets, pleated filters, filter cartridges, filter bags, filter tubes, and the like.

53. A charged multiple component, nonwoven filtration media which comprises
a blend of micro-denier fibers and fine-denier fibers, said blend being formed into one or more sheets, said sheets being multilayered in a graded density structure and needle punched to bond said sheets together, and
a charge treatment applied to said bonded sheets.

54. The media of claim 53 wherein 10-90% of polypropylene or other low melting temperature fibers, including bi-component fibers, are used in a blend to achieve enhanced thermal processing capabilities.

55. The media of claim 53 wherein the charge applied is a cationic or anionic resin.

56. The media of claim 55 wherein the applied cationic resin is polyamide-epichlorohydrin.

57. The media of claim 53 wherein the fabric density, air permeability, and mean pore size can be controlled through heated calendaring and densification of the bonded sheets, including smooth, textured, or patterned calendar rolls.

58. The media of claim 53 wherein the bonded sheets can be formed into flat or curved filter sheets, pleated filters, filter cartridges, filter bags, filter tubes, and the like.

59. A charged multiple component, nonwoven filtration media which comprises
a blend of micro-denier fibers and coarse-denier fibers, said blend being formed into one or more sheets, said sheets being multilayered in a graded density structure and needle punched to bond said sheets together, and
a charge treatment applied to said bonded sheets.

60. The media of claim 59 wherein 10-90% of polypropylene or other low melting temperature fibers, including bi-component fibers, are used in a blend to achieve enhanced thermal processing capabilities.

61. The media of claim 59 wherein the charge applied is a cationic or anionic resin.

62. The media of claim 61 wherein the applied cationic resin is polyamide-epichlorohydrin.

63. The media of claim 59 wherein the fabric density, air permeability, and mean pore size can be controlled through heated calendaring and densification of the bonded sheets, including smooth, textured, or patterned calendar rolls.

64. The media of claim 59 wherein the bonded sheets can be formed into flat or curved filter sheets, pleated filters, filter cartridges, filter bags, filter tubes, and the like.
